(19) United States
(12) Patent Application Publication
(10) Pub. No.: US 2024/0019364 A1
(43) Pub. Date: Jan. 18, 2024

(54) HIGH-ORDER HARMONIC OBSERVATION DEVICE AND HIGH-ORDER HARMONIC OBSERVATION METHOD

(71) Applicant: TOHOKU UNIVERSITY, Sendai-shi, Miyagi (JP)

(72) Inventors: Shinichiro IWAI, Sendai-shi (JP); Yohei KAWAKAMI, Sendai-shi (JP)

(73) Assignee: TOHOKU UNIVERSITY, Sendai-shi, Miyagi (JP)

(21) Appl. No.: 18/039,741

(22) PCT Filed: Dec. 9, 2021
(86) PCT No.: PCT/JP2021/045369

§ 371 Date: Jun. 1, 2023

(30) Foreign Application Priority Data
Dec. 10, 2020 (JP) 2020-205358

(51) Int. Cl. G01N 21/45; G02F 1/01

(52) U.S. Cl. CPC G01N 21/45; G02F 1/0136; G02F 2201/20

(57) ABSTRACT

A high-order harmonic observation device includes: an output unit which outputs a first pulse light having a prescribed wavelength and a prescribed pulse width; an optical delay circuit to which the first pulse light is input, and which coaxially outputs a pair of second pulse lights having a time difference relative to each other and inputs the pair of second pulse lights to a measurement object to generate a high-order harmonic; and a detection unit which detects the high-order harmonic.

### BACKGROUND ART

Currently, online social activities have been dramatically advanced. Therefore, it is necessary to solve the problem of a rapid increase in communication traffic. Currently, attempts for establishment and practical use of the technology from giga (109) hertz to terahertz have been actively made. The communication after 5 years or 10 years is expected to be dramatically improved to the peta (1015) hertz basic technology (electronics, photonics). In the petahertz basic technology, it is necessary to measure a petahertz current. The petahertz current is a high-frequency (up to 1015) current generated by electric field vibration of a light (visible light to near-infrared light) driving electrons in a solid. In the related art, measurement of a petahertz transient current flowing between nano (10⁻⁹) gap electrodes is performed using an insulator or graphene (see, for example, NPLs 1 and 2). In addition, it is reported that a petahertz current in a nanometal is measured using a principle of photoelectron emission (see, for example, NPL 3).

### CITATION LIST

### Non Patent Literature

NPL 1: Schiffrin, A. et al., Optical-field-induced current in dielectrics, Nature 493, 70-74 (3 Jan. 2013).
NPL 2: T. Higuchi, T. et al. ‘Light-field driven currents in graphene’ Nature 550, 224-228(2017).
NPL 3: B. Piglosiewicz, B. et al. ‘Carrier-envelope phase effects on the strong-field photoemission of electrons from metallic nanostructures' Nature Photonics 8, 37-42 (2013).
NPL 4: J. Rehault, et al., ‘Two-dimensional electronic spectroscopy with birefringent wedges' Review of Scientific Instruments 85, (2014).
NPL 5: A. D. Sio, et al., ‘Tracking the coherent generation of polaron pairs in conjugated polymers' Nature Communications 7, 13742 (2016).
NPL 6: J. M. Richter, et al., ‘Ultrafast carrier thermalization in lead iodide perovskite probed with two-dimensional electronic spectroscopy’ Nature Communications 8, 376 (2017).
NPL 7: Y. Kawakami, et al.,’ Petahertz non-linear current in a centrosymmetric organic superconductor’ Nature Communications 11, Article number: 4138 (2020), 18 Aug. 2020.

### SUMMARY OF INVENTION

### Technical Problem

In addition to a most distal end light source such as a carrier envelope phase (CEP) control stabilized laser having a pulse width of 10 femtoseconds (fs) or less, a special measurement device of transient current measurement or photoelectron spectroscopy between nanogap electrodes is necessary in the measurement of the petahertz current, and it is not easy to perform the measurement in a simple manner. In particular, in material development, a large-scale device for performing analysis by forming a low-temperature environment or a high-temperature environment is required, and an actual measurement example is limited to, for example, reports in the above literatures.

In the observation of the petahertz current, a measurement method in which an accuracy is in an atto (10⁻¹⁸) second region is indispensable. Usually, in order to implement such an interferometer having a high time accuracy, the interferometer is disposed in a vacuum chamber in order to reduce an influence of fluctuation of light generated due to air, and there is a problem that the device is large-scale.

An object of the present invention is to provide a high-order harmonic observation device and a high-order harmonic observation method capable of observing and analyzing a petahertz current in the atmosphere while simplifying a device configuration.

### Solution to Problem

An aspect of the invention is a high-order harmonic observation device including: an output unit configured to output a first pulse light having a prescribed wavelength and a prescribed pulse width, which are adjusted according to a high-order harmonic generated in a measurement object; an optical delay circuit to which the first pulse light is input, and configured to coaxially output a pair of second pulse lights having a time difference relative to each other and to input the pair of second pulse lights to the measurement object to generate the high-order harmonic; and a detection unit configured to detect the high-order harmonic.

The optical delay circuit according to the invention may include: a first polarization adjustment unit which is configured to receive the first pulse light, adjust a polarization direction in an oblique direction when viewed in an optical axis direction, and output the adjusted first pulse light; a delay unit which is provided downstream of the first polarization adjustment unit, and which is configured to apply a negative time delay to an input light and output the input light; a first adjustment unit which is provided downstream of or upstream of and adjacent to the delay unit, and which is configured to apply a relative time difference to a vertical component and a horizontal component of the input light and output an output light; and a second polarization adjustment unit which is provided downstream of the delay unit and the first adjustment unit, and which is configured to receive the output light, to cause a component of the output light in the oblique direction when viewed in the optical axis direction to pass through to generate the pair of second pulse lights, and to output the pair of second pulse lights.

The optical delay circuit according to the invention may include a second adjustment unit which is provided downstream of the delay unit and the first adjustment unit, and which is configured to adjust a pulse width of an input light.

The output unit according to the invention may generate the first pulse light having a wavelength of 1.5 μm band and a pulse width of approximately 6 fs.

The measurement object according to the invention is formed of an organic superconductor, which receives the pair of second pulse lights to generate a petahertz current, and generates the high-order harmonic.

An aspect of the invention is a high-order harmonic observation device including: an output unit configured to output a first pulse light having a prescribed wavelength and a prescribed pulse width, which are adjusted according to a high-order harmonic generated in a measurement object, and to input the first pulse light to the measurement object to generate the high-order harmonic; an optical delay circuit to which the high-order harmonic is input, and configured to coaxially output a pair of the high-order harmonics having a time difference relative to each other; and a detection unit configured to detect the high-order harmonics.

An aspect of the invention is a high-order harmonic observation method including: outputting, from an output unit, a first pulse light having a prescribed wavelength and a prescribed pulse width, which are adjusted according to a high-order harmonic generated in a measurement object; inputting the first pulse light to an optical delay circuit, generating and coaxially outputting a pair of second pulse lights having a time difference relative to each other; inputting the pair of second pulse lights to the measurement object to generate the high-order harmonic; and detecting the high-order harmonic by a detection unit.

In the optical delay circuit according to the invention, there may be configured as follows: a first polarization adjustment unit receives the first pulse light, rotates a polarization direction in an oblique direction when viewed in an optical axis direction, and outputs the rotated first pulse light, a delay unit applies a negative time delay to an input light and outputs the input light, a first adjustment unit outputs an output light obtained by applying a relative time difference to a vertical component and a horizontal component of the input light, and a second polarization adjustment unit receives the output light, causes a component of the output light in the oblique direction when viewed in the optical axis direction to pass through to generate the pair of second pulse lights having a time difference relative to each other, and outputs the pair of second pulse lights.

An aspect of the invention is a high-order harmonic observation method including: outputting, from an output unit, a first pulse light having a prescribed wavelength and a prescribed pulse width, which are adjusted according to a high-order harmonic generated in a measurement object; inputting the first pulse light to the measurement object to generate the high-order harmonic; inputting the high-order harmonic to an optical delay circuit to generate a pair of the high-order harmonics having a time difference relative to each other and coaxially outputting the pair of high-order harmonics; and detecting the pair of high-order harmonics by a detection unit.

A high-order harmonic observation method includes: by using a first observation result and a second observation result which are obtained based on the two different high-order harmonic observation methods according to the invention, the first observation result being obtained by observing a high-order harmonic of a prescribed order generated in the measurement object, the second observation result being obtained by observing the high-order harmonic of the prescribed order, evaluating a generation state of a vibration current having a frequency component of a high-order harmonic higher in order than the high-order harmonic of the prescribed order inside the measurement object.

### Advantageous Effects of Invention

According to the invention, it is possible to observe and analyze a petahertz current in the atmosphere while simplifying a device configuration.

### BRIEF DESCRIPTION OF DRAWINGS

FIG. 1 is a block diagram showing a configuration of a high-order harmonic observation device according to an embodiment.

FIG. 2 is a diagram conceptually showing the configuration of the high-order harmonic observation device.

FIG. 3 is a perspective view conceptually showing a configuration of an optical delay circuit.

FIG. 4 is a flowchart showing processing of a high-order harmonic observation method.

FIG. 5 is a diagram showing a change in an observed interference spectrum.

FIG. 6 is a diagram showing a change in an observed interference spectrum according to a comparative example.

FIG. 7 is a diagram showing a coaxial SHG autocorrelation.

FIG. 8 is a diagram showing a Fourier transform spectrum of an observation result.

FIG. 9 is a diagram showing a time axis interference profile of an observation object.

FIG. 10 is a diagram showing a spectrum obtained by performing Fourier transform on the time axis interference profile of the observation object.

FIG. 11 is a block diagram showing a configuration of a high-order harmonic observation device according to a modification.

FIG. 12 is a diagram showing an observation result of the high-order harmonic observation device according to the modification.

### DESCRIPTION OF EMBODIMENTS

Hereinafter, embodiments of a high-order harmonic observation device and a harmonic detection method according to the invention will be described.

As a result of earnest studies to observe a petahertz current, the inventors found a basic novel principle (see, for example, NPL 7). The principle is that a current whose direction is determined is generated at the moment when a prescribed organic superconductor is irradiated with a light pulse having a fairly short time width. With the current whose direction is determined, an even-order harmonic to be originally forbidden is activated by a petahertz nonlinear current in the superconductor having inversion symmetry. This means that a petahertz current generated in a solid can be observed as an even-order harmonic. The invention relates to a high-order harmonic observation device and a harmonic detection method for observing and analyzing a petahertz current as a time axis interference profile of an even-order harmonic based on this principle.

A method of generating a pair of pulse lights that travel coaxially from an input light has already been implemented in a visible region to a near-infrared (800 nm) region as a device of an optical system “translating wedge-based identical pulses encoding system (TWINS)” that generates a pair of pulse lights using birefringence of the uniaxial crystal. The above-described optical system (TWINS) for generating the pair of pulse lights is mainly used for pump probe measurement or the like (see, for example, NPLs 4 to 6). However, there is no report example in which the TWINS is used for measurement in the 1.5 μm band of near-infrared light, which is a communication wavelength band, and there is no example in which the TWINS is applied to measurement of a harmonic.

The TWINS includes an optical delay circuit that uses the birefringent optical element to generate an optical delay by a difference in a refractive index depending on a polarization direction. Here, birefringence refers to a phenomenon in which when a light beam passes through a substance having a crystal structure, the light beam is split into two light beams depending on a state of the polarization. A pulse light input to the TWINS is birefringent to become a pair of pulse lights, which are output in coaxial optical paths. Since the TWINS has a minimum mechanical configuration using the birefringent optical element, the TWINS is characterized in that the TWINS is less likely to be affected by a mechanical accuracy and disturbance.

According to the TWINS, in principle, it is possible to easily achieve measurement having a time accuracy of 50 atto seconds (as) or less. So far, even when a moving stage having a normal mechanical accuracy is used, measurement having a time accuracy of about 100 atto seconds is achieved by using the TWINS. For the observation of the petahertz current, a measurement method in an atto second region is indispensable. Usually, in order to implement such an interferometer having a high time accuracy, the interferometer is disposed in a vacuum chamber, which causes a large-scale device configuration. As compared with this, the TWINS has a simplified device configuration, and can perform measurement in the atmosphere. Therefore, if the TWINS can be used for measuring light in the 1.5 μm band of near-infrared light, a highly stable high-order harmonic observation device can be implemented while simplifying the device configuration.

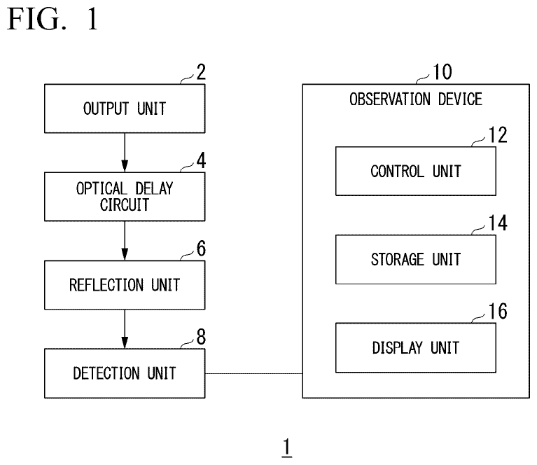

As shown in FIG. 1, a high-order harmonic observation device 1 includes an output unit 2 which generates a first pulse light, an optical delay circuit 4 to which the first pulse light is input and which outputs a pair of second pulse lights, a reflection unit 6 which is formed of an organic superconductor generating a high-order harmonic, a detection unit 8 which detects the high-order harmonic generated in the reflection unit, and an observation device 10 which performs observation based on a detection value.

The output unit 2 outputs the first pulse light having a prescribed wavelength and a prescribed pulse width, which are adjusted according to a high-order harmonic generated in the reflection unit 6 (measurement object). The output unit 2 generates, for example, a laser light of a near-infrared light having a communication wavelength band. The output unit 2 generates, for example, the first pulse light having a wavelength of 1.5 μm band and a prescribed pulse width (about 6 femtoseconds). The pulse width is adjusted to a time corresponding to one cycle of electric field vibration in the near-infrared light having the communication wavelength band.

The optical delay circuit 4 is disposed in the atmosphere. The first pulse light is input to the optical delay circuit 4, and the optical delay circuit 4 outputs the pair of second pulse lights having a phase (time) difference relative to each other. The optical delay circuit 4 is implemented by, for example, a birefringent optical element that generates an optical delay by a difference in a refractive index depending on a polarization direction. The optical delay circuit 4 causes the input first pulse light to pass through the birefringent optical element, generates the pair of second pulse lights having the time difference, and outputs the pair of second pulse lights in coaxial optical paths. The optical delay circuit 4 functions as an interferometer that changes a state of an output interference light by adjusting a relative phase difference applied to the pair of second pulse lights.

The optical delay circuit 4 has a configuration that is less likely to be affected by a mechanical accuracy and disturbance by being provided with the birefringent optical element. Therefore, the optical delay circuit 4 has 200 times the time accuracy of a mechanical interferometer in principle.

The reflection unit 6 is formed of, for example, a prescribed organic superconductor (κ-(BEDT-TTF)₂Cu[N(CN)₂]Br) which is the measurement object. The reflection unit 6 has a property of generating a petahertz current and generating a second-order or higher order harmonic when the pair of second pulse lights are input to the reflection unit 6 (see NPL 7). The detection unit 8 detects the high-order harmonic generated in the reflection unit 6.

The observation device 10 includes, for example, a control unit 12 that generates a display image based on a detection value detected by the detection unit 8, a storage unit 14 that stores various types of data necessary for processing, and a display unit 16 that outputs the generated display image. The observation device 10 is implemented by an information processing terminal such as a personal computer.

The control unit 12 is implemented by, for example, a hardware processor such as a central processing unit (CPU) executing a program (software). A part or all of these components may be implemented by hardware (including circuit unit and circuitry) such as a large scale integration (LSI), an application specific integrated circuit (ASIC), a field-programmable gate array (FPGA), and a graphics processing unit (GPU), or may be implemented by cooperation of the software and the hardware. The program may be stored in advance in a storage device such as a hard disk drive (HDD) or a flash memory, may be stored in a detachable storage medium such as a DVD or a CD-ROM, and may be installed by mounting the storage medium in a drive device. The control unit 12 may control, in addition to the display of the display image on the display unit 16, a first adjustment unit 4C and a second adjustment unit 4D in the optical delay circuit 4 to be described later.

The storage unit 14 is a storage device such as an HDD or a flash memory. In addition to data such as a threshold to be described later, a program for executing processing of the control unit 12 is stored. The data and the program may be stored in an external server connected to a network.

An image of an observation result generated based on the detection value is displayed on the display unit 16. The display unit 16 is a display device such as a liquid crystal display, a light emitting diode (LED) display, an organic electro-luminescence (EL) display, a digital mirror device (DAC), and a plasma display. The display unit 16 may be implemented by an information processing terminal such as a smartphone or a tablet terminal provided separately from the observation device 10.

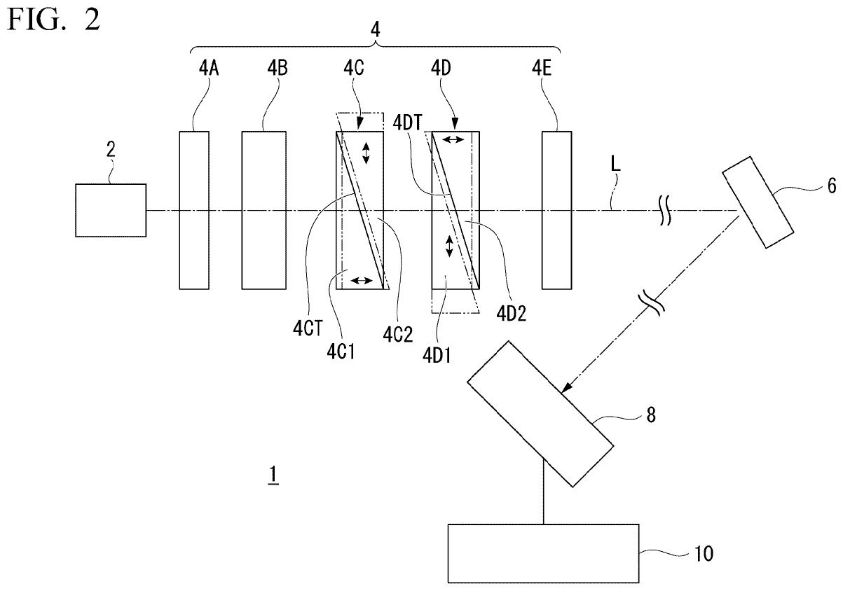

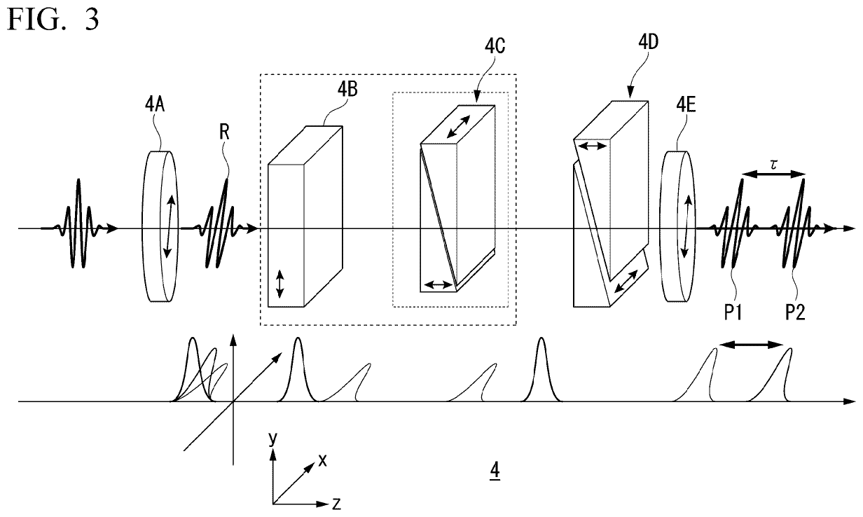

As shown in FIGS. 2 and 3, in the optical delay circuit 4, a first polarization adjustment unit 4A is provided downstream of a first pulse light R output from the output unit 2 in an optical axis L direction. A delay unit 4B is provided downstream of the first polarization adjustment unit 4A. The first adjustment unit 4C is provided downstream of and adjacent to the delay unit 4B. The first adjustment unit 4C may be provided upstream of and adjacent to the delay unit 4B. That is, the first adjustment unit 4C is provided downstream of or upstream of and adjacent to the delay unit 4B.

The second adjustment unit 4D is provided downstream of the delay unit 4B and the first adjustment unit 4C. A second polarization adjustment unit 4E is provided downstream of the second adjustment unit 4D. The second polarization adjustment unit 4E is provided downstream of the delay unit 4B, the first adjustment unit 4C, and the second adjustment unit 4D. A three-dimensional coordinate axis shown in FIG. 3 is an example indicating a relative relationship, and is not limited thereto.

The first polarization adjustment unit 4A receives a light, rotates the polarization direction in an oblique direction when viewed in the optical axis L direction, and outputs the light. The first polarization adjustment unit 4A is formed of, for example, a half-wave plate. For example, the first polarization adjustment unit 4A receives the first pulse light from the upstream side, and outputs a light (in the embodiment, the first pulse light) whose polarization direction is adjusted to 450 with respect to an upper-lower direction when viewed from the downstream side in the optical axis L direction.

The delay unit 4B applies a negative phase delay to the input light, and outputs the input light. The delay unit 4B is formed in a rectangular plate shape by, for example, an α-BBO (α-BaB₂O₄) crystal. The α-BBO of the delay unit 4B is a uniaxial crystal formed on a y-cut having a prescribed optical characteristic. The y-cut is cut such that a y-axis direction of the uniaxial crystal coincides with a direction of an extraordinary refractive index of the uniaxial crystal. The α-BBO has high birefringence in a transmission wavelength range of 190 nm to 3500 nm. The first pulse light whose polarization direction is adjusted to 450 with respect to a vertical direction when viewed in the optical axis L direction is input to the delay unit 4B. The delay unit 4B applies a negative phase delay to the first pulse light, and outputs the first pulse light. A delay amount of the phase in the delay unit 4B is adjusted according to a plate thickness (for example, 3.5 mm) of the delay unit 4B in the optical axis L direction.

The first adjustment unit 4C relatively applies a phase difference to a vertical component and a horizontal component of the input light, and outputs an output light. The first adjustment unit 4C includes, for example, a first wedge portion 4C1 and a second wedge portion 4C2 that are formed in a wedge shape when viewed in a direction orthogonal to the optical axis L. The first adjustment unit 4C is formed in a rectangular plate shape by combining the first wedge portion 4C1 on the upstream side and the second wedge portion 4C2 on the downstream side. In the first adjustment unit 4C, a parallel adjacent space 4CT is formed between the first wedge portion 4C1 and the second wedge portion 4C2 when viewed in the direction orthogonal to the optical axis L, in an oblique direction with respect to the direction orthogonal to the optical axis L.

The first wedge portion 4C1 is formed of, for example, an x-cut α-BBO crystal. The x-cut is cut such that an x-axis direction of the uniaxial crystal coincides with the direction of the extraordinary refractive index of the uniaxial crystal. The first wedge portion 4C1 is formed to have a prescribed gradient (for example, a ratio of a plate surface length to a plate thickness: 3.5 mm/25 mm, angle: 7°). The second wedge portion 4C2 is formed of, for example, a z-cut α-BBO crystal having a refractive index different from that of the first wedge portion 4C1. The x-cut is cut such that a z-axis direction of the uniaxial crystal coincides with the direction of the extraordinary refractive index of the uniaxial crystal. The second wedge portion 4C2 is formed to have a prescribed gradient (for example, 3.5 mm/25 mm, angle: 7°).

The first wedge portion 4C1 is movable in a prescribed width (for example, 3 mm) along the optical axis L direction. The second wedge portion 4C2 is movable in a prescribed width (for example, 3 mm) along the direction orthogonal to the optical axis L. By relatively moving the first wedge portion 4C1 and the second wedge portion 4C2 along the adjacent space 4CT, an optical path length in the first adjustment unit 4C in the optical axis L is adjusted, and the phase difference (time difference) that is relatively applied to the vertical component and the horizontal component of the input light is adjusted to output the output light.

The second adjustment unit 4D adjusts a pulse width of the input light. The second adjustment unit 4D adjusts the pulse width of the pulse light changed by passing through the delay unit 4B and the first adjustment unit 4C. Similarly to the first adjustment unit 4C, the second adjustment unit 4D includes, for example, a first wedge portion 4D1 and a second wedge portion 4D2 that are formed in a wedge shape when viewed in the direction orthogonal to the optical axis L. The second adjustment unit 4D is formed in a rectangular plate shape by combining the first wedge portion 4D1 on the upstream side and the second wedge portion 4D2 on the downstream side.

In the second adjustment unit 4D, a parallel adjacent space 4DT is formed between the first wedge portion 4D1 and the second wedge portion 4D2 when viewed in the direction orthogonal to the optical axis L, in an oblique direction with respect to the direction orthogonal to the optical axis L. The first wedge portion 4D1 is formed of, for example, a z-cut α-BBO crystal. The first wedge portion 4D1 is formed to have a prescribed gradient (for example, 3.5 mm/25 mm, angle: 7°). The second wedge portion 4D2 is formed of, for example, an x-cut α-BBO crystal having a refractive index different from that of the first wedge portion 4D1. The second wedge portion 4D2 is formed to have a prescribed gradient (for example, 3.5 mm/25 mm, angle: 7°).

The first wedge portion 4D1 is movable in a prescribed width (for example, 3 mm) along the direction orthogonal to the optical axis L. The second wedge portion 4D2 is movable in a prescribed width (for example, 3 mm) along the optical axis L direction. By relatively moving the first wedge portion 4D1 and the second wedge portion 4D2 along the adjacent space 4DT, an optical path length in the second adjustment unit 4D in the optical axis L is adjusted, wavelengths of the vertical component and the horizontal component of the input light are adjusted, and a pulse width of the output pulse light is adjusted to the original width.

A component in an oblique 45° direction with respect to the vertical direction when viewed in the optical axis L direction of the output light to be received passes through the second polarization adjustment unit 4E to generate and output a pair of second pulse lights P1 and P2 having a phase (time) difference relative to each other. The second polarization adjustment unit 4E is formed of, for example, a polarization plate disposed such that the polarization direction is 450 with respect to the vertical direction. The pair of second pulse lights P1 and P2 output from the second polarization adjustment unit 4E are input to the reflection unit 6.

In the first adjustment unit 4C, by adjusting the time difference included in the output light, the time difference between the pair of second pulse lights P1 and P2 output from the second polarization adjustment unit 4E is adjusted, and the interference light is generated. When the interference light is input to the measurement object, an interference spectrum of a high-order harmonic generated from the measurement object is detected by the detection unit 8.

Next, a flow of processing of a high-order harmonic observation method will be described.

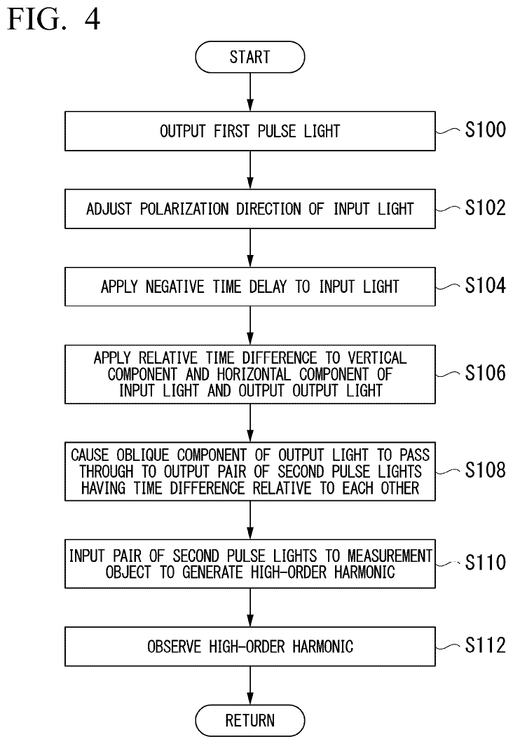

FIG. 4 is a flowchart showing the processing of the high-order harmonic observation method. The output unit 2 outputs the first pulse light having the prescribed wavelength and the prescribed pulse width, which are adjusted according to the high-order harmonic generated in the measurement object (the reflection unit 6) (step S100). The first polarization adjustment unit 4A adjusts the polarization direction of the first pulse light which is the input light in an oblique direction when viewed in the optical axis L direction, and outputs the first pulse light (step S102).

The delay unit 4B applies a negative phase (time) delay to the input light, and outputs the input light (step S104). The first adjustment unit 4C adjusts a phase of the vertical component of the input light, adjusts a phase of the horizontal component, and outputs an output light obtained by applying the relative phase (time) difference to the vertical component and the horizontal component (step S106). Steps S104 and S106 may be interchanged. The second polarization adjustment unit 4E receives the output light, and causes a component of the output light in the oblique direction when viewed in the optical axis L direction to pass through to generate and output the pair of second pulse lights P1 and P2 having the phase (time) difference relative to each other (step S108).

The pair of second pulse lights P1 and P2 are input to the measurement object to generate a pair of high-order harmonics (step S110). The detection unit 8 detects the pair of high-order harmonics, and observes, based on the pair of high-order harmonics displayed on the display unit 16, a detection result of an interference signal of the generated interference light (step S112).

Next, a comparison result in a time accuracy and stability between the high-order harmonic observation device 1 and a normal Michelson interferometer type pulse pair generating optical system (stage interferometer) will be described.

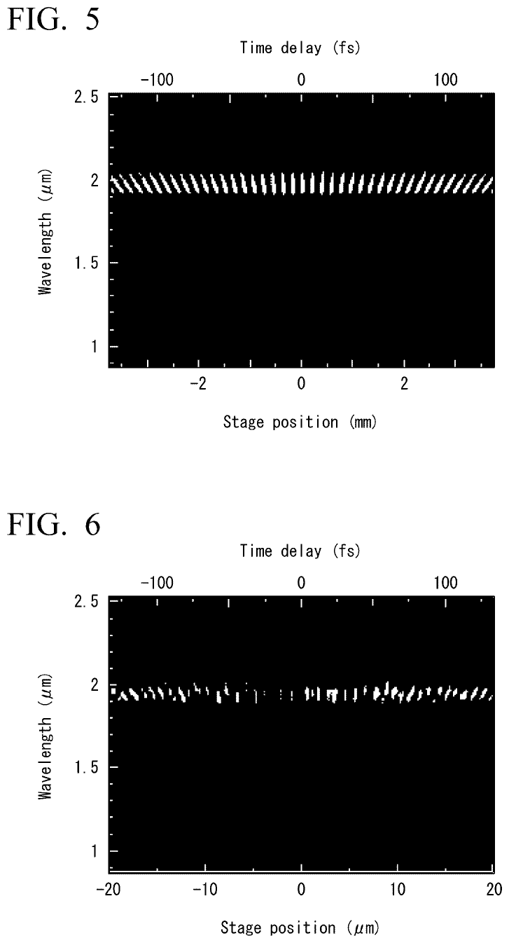

FIG. 5 shows, as a 2D plot, a change (vertical axis) of an interference spectrum (one scan) when the time difference (horizontal axis) between the pair of second pulse lights P1 and P2 is changed by the high-order harmonic observation device 1. FIG. 6 shows an observation result of the interference spectrum using the normal Michelson interferometer. As shown in the drawing, when signals of the stage interferometer are compared, the high-order harmonic observation device 1 has a higher degree of stability than the normal Michelson interferometer. Based on the observation result, when integration measurement assumed during actual physical property measurement is performed, a difference in visibility of an interference waveform reaches approximately one order of magnitude. Furthermore, when the Michelson interferometer is used, in order to eliminate an influence of air to improve the accuracy of the observation, equipment for maintaining the device in vacuum is required, and the equipment is increased in size. As compared with this, according to the high-order harmonic observation device 1, the observation can be performed by using the simplified optical delay circuit 4 in the atmosphere, and the device configuration can be greatly simplified.

According to the high-order harmonic observation device 1, adjustment widths of the first adjustment unit 4C and the second adjustment unit 4D corresponding to a time difference 100fs between the pair of second pulse lights P1 and P2 to be generated are approximately 3 mm. In the normal Michelson interferometer, an adjustment width of a stage corresponding to a time difference 100fs of an interference light to be generated is 0.015 mm. Accordingly, according to the high-order harmonic observation device 1, the adjustment can be facilitated compared with the normal Michelson interferometer, and the accuracy 200 times higher than that of the normal Michelson interferometer can be achieved.

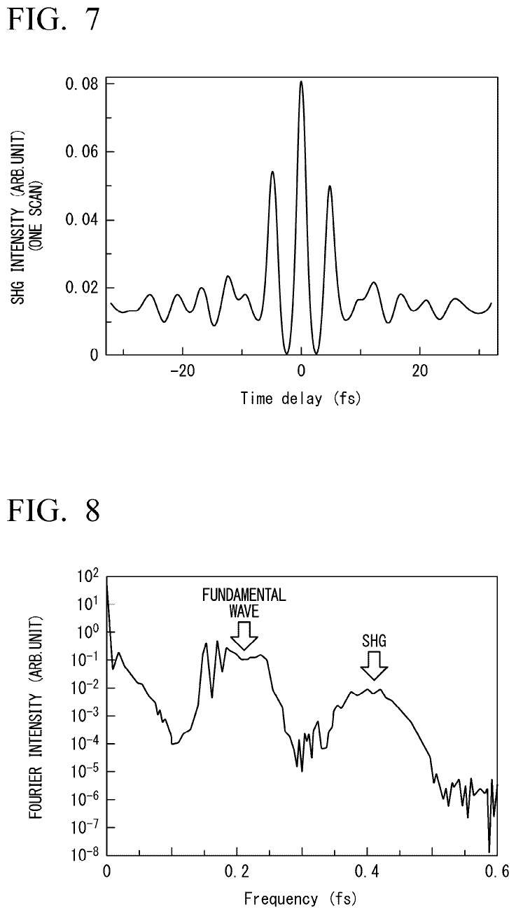

FIG. 7 shows a coaxial second harmonic generation (SHG) autocorrelation (medium is β-BBO). As shown in the drawing, in a current time waveform, a time accuracy of at least about 200 atto seconds is obtained.

As shown in FIG. 8, a Fourier transform spectrum of the observation result includes an SHG component in addition to an interference signal corresponding to an electric field vibration cycle of a fundamental wave. The high-order harmonic observation device 1 has an accuracy of about 50 atto seconds in principle, and when a mechanical accuracy of the stage is set to about 1 fs, higher order harmonics can be measured. Setting of the mechanical accuracy of the stage to 1 fs is easy in the related art, and when a highly accurate mechanical operation stage is applied to the high-order harmonic observation device 1, observation having a higher accuracy can be performed.

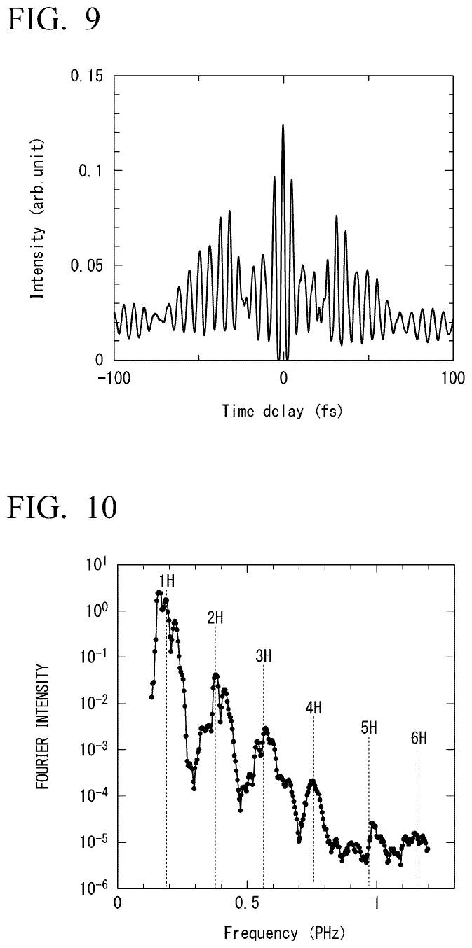

FIG. 9 shows a time axis interference profile of an observation object κ-(BEDT-TTF)₂Cu[N(CN)₂]Br. FIG. 10 shows a spectrum obtained by performing Fourier transform on the time axis interference profile of the κ-(BEDT-TTF)₂Cu[N(CN)₂]Br. As shown in the drawing, in addition to the third-order and the fifth-order harmonics, SHG by a nonlinear petahertz current is observed. In addition, a fourth-order harmonic which is higher in order is also observed. As shown in the drawing, according to the high-order harmonic observation device 1, a fifth-order harmonic which is higher in order can be further observed, and an accuracy of an interferometer to be configured can be set to be 100 atto seconds or less. According to the high-order harmonic observation device 1, it is possible to observe and analyze the petahertz current in the atmosphere while simplifying the device configuration.

### [Modification]

Hereinafter, a high-order harmonic observation device 1A according to a modification will be described. In the following description, the same components as those of the above-described embodiment are denoted by the same names and reference numerals, and redundant description thereof will be omitted as appropriate.

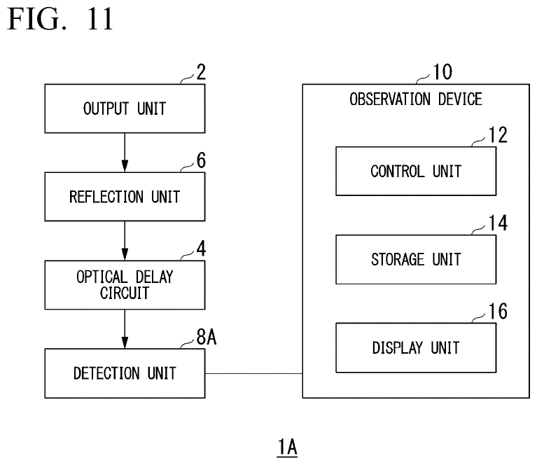

As shown in FIG. 11, the high-order harmonic observation device 1A according to the modification is different from the high-order harmonic observation device 1 in the arrangement position of the optical delay circuit 4 on the optical path. The high-order harmonic observation device 1A includes, for example, the output unit 2 that generates a first pulse light. The reflection unit 6 (measurement object) is provided downstream of the output unit 2. The optical delay circuit 4 is provided downstream of the reflection unit 6. A detection unit 8A is provided downstream of the optical delay circuit 4. The detection unit 8A is connected to the observation device 10. The detection unit 8A detects, for example, a wavelength region (for example, an ultraviolet region) of a high-order harmonic which is higher in order as compared with a wavelength region (for example, a near-infrared region to a visible region) including high-order harmonics, which are lower in order, such as a second-order harmonic and a third-order harmonic, which can be detected by the detection unit 8 provided in the high-order harmonic observation device 1.

That is, the output unit 2 outputs the first pulse light having a prescribed wavelength and a prescribed pulse width, which are adjusted according to a high-order harmonic generated in the measurement object. The reflection unit 6 receives the first pulse light and generates a high-order harmonic. The generated high-order harmonic is input to the optical delay circuit 4 to coaxially output a pair of high-order harmonics having a time difference relative to each other. The detection unit 8 detects an interference signal of an interference light generated based on the pair of high-order harmonics. The observation device 10 displays a display image of the detected interference light on the display unit 16.

The high-order harmonic observation device 1A according to the modification is used to evaluate a state of a vibration current generated inside the measurement object by performing observation in combination with the high-order harmonic observation device 1. The high-order harmonic observation device 1 can be used, for example, to find a measurement object that generates a high-order harmonic. According to the high-order harmonic observation device 1, for example, a pair of pulse lights are input as an interference signal to the measurement object, and high-order harmonics having wavelength regions of a second-order harmonic and a third-order harmonic generated based on the interference signal output from the measurement object are detected by the detection unit 8. According to the high-order harmonic observation device 1, by dispersing a detection result in the wavelength regions of the second-order harmonic and the third-order harmonic, it is possible to evaluate whether a light of the fourth-order harmonic which is higher in order affects lights of the second-order harmonic and the third-order harmonic.

When it is found that the measurement object generates a vibration current based on a high-order harmonic by the observation of the high-order harmonic observation device 1, the high-order harmonic observation device 1A according to the modification can be used to observe an influence of the vibration current that is a source of a higher order harmonic. That is, according to the high-order harmonic observation device 1A, it is possible to confirm whether the high-order harmonic is truly generated as a component of the light in the measurement object.

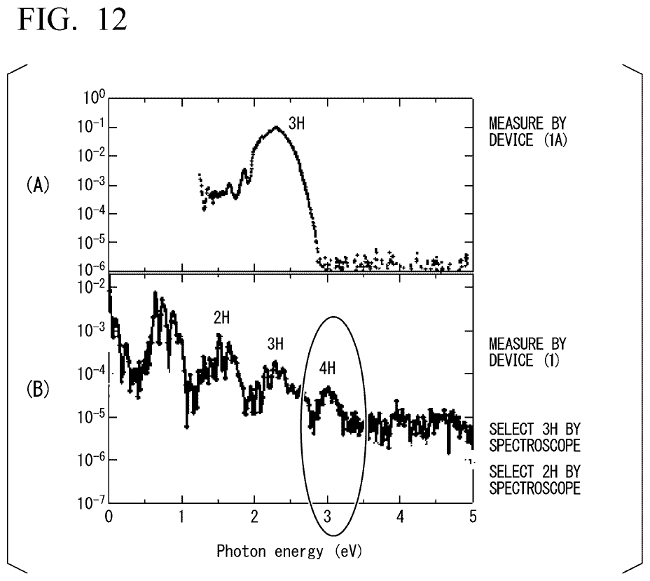

(A) of FIG. 12 shows a detection result of photon energy based on the interference signals of the second-order harmonic and the third-order harmonic of the measurement object (for example, k-(h-ET)₂Cu[N(CN)₂]Br(h-Br)) observed by the high-order harmonic observation device 1A according to the modification. (B) of FIG. 12 shows the detection result of the photon energy (vibration current) of the second-order harmonic and the third-order harmonic on the measurement object observed by the high-order harmonic observation device 1 according to the above-described embodiment.

As shown in (B) of FIG. 12, for example, among detection data of the interference signals detected by the detection unit 8 provided in the high-order harmonic observation device 1, components of the third-order harmonic are dispersed and detected using a spectroscope. At this time, components of the fourth-order harmonic higher in order than the third-order harmonic are detected in the Fourier transform spectrum of the detection result in addition to a fundamental harmonic and the second-order harmonic which are lower in order than the third-order harmonic. The fundamental harmonic lower in order than the third-order harmonic is usually observed based on a basic principle of nonlinear optics.

However, even though the components of the fourth-order harmonic higher in order than the third-order harmonic are excluded as the component of the light by the spectroscope, the vibration current of the components of the fourth-order harmonic is detected. This indicates that the vibration current of the fourth-order harmonic affects the vibration current of the third-order harmonic inside the measurement object. As shown in (B) of FIG. 12, when the components of the second-order harmonic among the detection data detected by the detection unit 8 are dispersed and detected using the spectroscope, the components of the third-order harmonic and the fourth-order harmonic are detected in the same manner. Accordingly, based on the detection result in (B) of FIG. 12, it is possible to evaluate whether a polarization current that is a generation source of the fourth-order harmonic is generated inside the measurement object.

As shown in (A) of FIG. 12, when the same measurement object is measured by the high-order harmonic observation device 1A according to the modification, only a high-order harmonic actually output as a component of the light from the measurement object can be observed. In the example of (A) of FIG. 12, it can be seen that the fourth-order harmonic is not output as the component of the light in the measurement object. Compared with the detection result in (B) of FIG. 12, it can be seen that although, for example, the fourth-order harmonic is not output as the light in the measurement object, a vibration current having a frequency component of the fourth-order harmonic is generated inside the measurement object.

Accordingly, based on a first observation result of a high-order harmonic of a prescribed order obtained by observing the measurement object using the high-order harmonic observation device 1 (see (B) of FIG. 12) and a second observation result of the high-order harmonic of the prescribed order obtained by observing the measurement object using the high-order harmonic observation device 1A (see (A) of FIG. 12), it is possible to evaluate a generation state of a vibration current such as the presence or absence of a vibration current having a frequency component of a high-order harmonic higher in order than the prescribed order inside the measurement object. The reason why it is effective to use the high-order harmonic observation device 1 and the high-order harmonic observation device 1A in combination is as follows. In order to detect the high-order harmonic as the component of the light in the measurement object, it is necessary to process the measurement object into an appropriate sample shape such as a thin film having no loss. However, when measurement is first performed by the high-order harmonic observation device 1 regardless of a sample shape without processing the measurement object and a vibration current is observed, the measurement object is processed into the appropriate sample shape and then observed using the high-order harmonic observation device 1A, and a substance that generates a high-order harmonic can be efficiently found.

While certain embodiments have been described, these embodiments have been presented by way of examples only, and are not intended to limit the scope of the invention. The embodiments can be implemented in various other forms, and various omissions, substitutions, and changes can be made without departing from the gist of the invention. The embodiments and variations thereof are included within the scope of the claims and equivalents thereof as well as within the scope and gist of the invention. For example, although the high-order harmonic observation device 1 applies the TWINS to the optical delay circuit 4 as an example, another optical delay circuit may be used as long as the first pulse light can be input to the optical delay circuit to coaxially output the pair of second pulse lights having the time difference relative to each other. In addition, the observation of the high-order harmonic in the above embodiment includes detecting the vibration current generated in the measurement object.

### REFERENCE SIGNS LIST

1, 1A: high-order harmonic observation device
2: output unit
4: optical delay circuit
4A: first polarization adjustment unit
4B: delay unit
4CT: adjacent space
4C: first adjustment unit
4C1: first wedge portion
4C2: second wedge portion
4D: second adjustment unit
4D1: first wedge portion
4D2: second wedge portion
4DT: adjacent space
4E: second polarization adjustment unit
6: reflection unit
8, 8A: detection unit
10: observation device
12: control unit
14: storage unit
16: display unit
L: optical axis
P1, P2: second pulse light
R: first pulse light

1. A high-order harmonic observation device comprising:
an output unit configured to output a first pulse light having a prescribed wavelength and a prescribed pulse width, which are adjusted according to a high-order harmonic generated in a measurement object;
an optical delay circuit to which the first pulse light is input, and configured to coaxially output a pair of second pulse lights having a time difference relative to each other and to input the pair of second pulse lights to the measurement object to generate the high-order harmonic; and
a detection unit configured to detect the high-order harmonic.

2. The high-order harmonic observation device according to claim 1, wherein the optical delay circuit includes:
a first polarization adjustment unit which is configured to receive the first pulse light, adjust a polarization direction in an oblique direction when viewed in an optical axis direction, and output the adjusted first pulse light,
a delay unit which is provided downstream of the first polarization adjustment unit, and which is configured to apply a negative time delay to an input light and output the input light,
a first adjustment unit which is provided downstream of or upstream of and adjacent to the delay unit, and which is configured to apply a relative time difference to a vertical component and a horizontal component of the input light and output an output light, and
a second polarization adjustment unit which is provided downstream of the delay unit and the first adjustment unit, and which is configured to receive the output light, to cause a component of the output light in the oblique direction when viewed in the optical axis direction to pass through to generate the pair of second pulse lights, and to output the pair of second pulse lights.

3. The high-order harmonic observation device according to claim 2, wherein the optical delay circuit includes a second adjustment unit which is provided downstream of the delay unit and the first adjustment unit, and which is configured to adjust a pulse width of an input light.

4. The high-order harmonic observation device according to claim 1, wherein the output unit is configured to generate the first pulse light having a wavelength of 1.5 m band and a pulse width of approximately 6 fs.

5. The high-order harmonic observation device according to claim 4, wherein the measurement object is formed of an organic superconductor, which receives the pair of second pulse lights to generate a petahertz current, and generates the high-order harmonic.

6. A high-order harmonic observation device comprising:
an output unit configured to output a first pulse light having a prescribed wavelength and a prescribed pulse width, which are adjusted according to a high-order harmonic generated in a measurement object, and to input the first pulse light to the measurement object to generate the high-order harmonic;
an optical delay circuit to which the high-order harmonic is input, and configured to coaxially output a pair of the high-order harmonics having a time difference relative to each other; and
a detection unit configured to detect the high-order harmonics.

7. A high-order harmonic observation method comprising:
outputting, from an output unit, a first pulse light having a prescribed wavelength and a prescribed pulse width, which are adjusted according to a high-order harmonic generated in a measurement object;
inputting the first pulse light to an optical delay circuit, generating and coaxially outputting a pair of second pulse lights having a time difference relative to each other;
inputting the pair of second pulse lights to the measurement object to generate the high-order harmonic; and
detecting the high-order harmonic by a detection unit.

8. The high-order harmonic observation method according to claim 7, wherein in the optical delay circuit,
a first polarization adjustment unit receives the first pulse light, rotates a polarization direction in an oblique direction when viewed in an optical axis direction, and outputs the rotated first pulse light,
a delay unit applies a negative time delay to an input light and outputs the input light,
a first adjustment unit outputs an output light obtained by applying a relative time difference to a vertical component and a horizontal component of the input light, and
a second polarization adjustment unit receives the output light, causes a component of the output light in the oblique direction when viewed in the optical axis direction to pass through to generate the pair of second pulse lights having a time difference relative to each other, and outputs the pair of second pulse lights.

9. A high-order harmonic observation method comprising:
outputting, from an output unit, a first pulse light having a prescribed wavelength and a prescribed pulse width, which are adjusted according to a high-order harmonic generated in a measurement object;
inputting the first pulse light to the measurement object to generate the high-order harmonic;
inputting the high-order harmonic to an optical delay circuit to generate a pair of the high-order harmonics having a time difference relative to each other and coaxially outputting the pair of high-order harmonics; and
detecting the pair of high-order harmonics by a detection unit.

10. A high-order harmonic observation method, comprising:
by using a first observation result and a second observation result, the first observation result being obtained by observing a high-order harmonic of a prescribed order generated in the measurement object based on a first high-order harmonic observation method, the second observation result being obtained by observing the high-order harmonic of the prescribed order generated in the measurement object based on a second high-order harmonic observation method, evaluating a generation state of a vibration current having a frequency component of a high-order harmonic higher in order than the high-order harmonic of the prescribed order inside the measurement object,
wherein the first high-order harmonic observation method includes:
outputting, from an output unit, a first pulse light having a prescribed wavelength and a prescribed pulse width, which are adjusted according to a high-order harmonic generated in a measurement object,
inputting the first pulse light to an optical delay circuit, generating and coaxially outputting a pair of second pulse lights having a time difference relative to each other,
inputting the pair of second pulse lights to the measurement object to generate the high-order harmonic, and
detecting the high-order harmonic by a detection unit, and
wherein the second high-order harmonic observation method includes:
outputting, from an output unit, a first pulse light having a prescribed wavelength and a prescribed pulse width, which are adjusted according to a high-order harmonic generated in a measurement object,
inputting the first pulse light to the measurement object to generate the high-order harmonic,
inputting the high-order harmonic to an optical delay circuit to generate a pair of the high-order harmonics having a time difference relative to each other and coaxially outputting the pair of high-order harmonics, and
detecting the pair of high-order harmonics by a detection unit.
